(19) United States
(12) Patent Application Publication
(10) Pub. No.: US 2015/0202702 A1
(43) Pub. Date: Jul. 23, 2015

(54) GAS TURBINE ENGINE CAST STRUCTURE METHOD FOR FINISHING

(71) Applicant: United Technologies Corporation, Hartford, CT (US)

(72) Inventors: John P. Rizzo, Vernon, CT (US); Gordon Miller Reed, Plantsville, CT (US)

(21) Appl. No.: 14/583,302

(22) Filed: Dec. 26, 2014

Related U.S. Application Data
(60) Provisional application No. 61/928,667, filed on Jan. 17, 2014.

(51) Int. Cl. B23H 3/00

(52) U.S. Cl. CPC B23H 3/00

(57) ABSTRACT

A method of finishing a cast structure includes providing a cast exterior surface with an undesired cast feature and electrochemically machining the undesired cast feature to provide a finished contour.

### CROSS-REFERENCE TO RELATED APPLICATIONS

This application claims priority to U.S. Provisional Application No. 61/928,667, which was filed on Jan. 17, 2014 and is incorporated herein by reference.

### BACKGROUND

This disclosure relates to a cast structure, such as an airfoil, for a gas turbine engine. The disclosure also relates to a method for finishing an exterior cast surface of the cast structure.

Typically, turbine airfoils are cast using an investment casting process, or lost wax process. A core is coated and then arranged in a mold and enveloped in wax, which provides a desired airfoil shape. The wax airfoil is subsequently coated in a ceramic slurry that is hardened into a shell. The wax is melted out of the shell, which is then filled with molten metal to provide the airfoil. The core provides the shape of internal cooling passages within the airfoil. The core may be removed chemically, for example.

In one common manufacturing process, the ceramic core exits the wax airfoil at one or more locations, such as at the airfoil's trailing edge. The area around this ceramic/wax airfoil interface is typically rough and requires post-casting operations to grind down the excess material. The post-casting operations are typically done by hand and, due to the curved contours of the surfaces of the airfoil, inspection of the final finished surface is difficult to quantify and qualify. As a result, the finally finished metal airfoil often includes undesired positive raised alloy material resulting in local discontinuities on the local external airfoil surface geometry.

In order to remove the positive material that results, hand finishing operations are required. If the hand finishing is severe or overly aggressive and deep into the local wall adjacent to the trailing edge coolant ejection location, a thin wall can be formed that will adversely impact the local thermal cooling performance and structural capability of the part. Local positive features or steps can cause disturbances within the boundary layer flow across the external surface of the airfoil, resulting in flow separation increasing aerodynamic losses. Additionally, the local positive features or steps can cause local body film cooling to eject into the gas path without properly attaching to the airfoil, adversely impacting the local thermal cooling performance.

### SUMMARY

In one exemplary embodiment, a method of finishing a cast structure includes providing a cast exterior surface with an undesired cast feature and electrochemically machining the undesired cast feature to provide a finished contour.

In a further embodiment of the above, the undesired cast feature is a gate.

In a further embodiment of any of the above, the undesired cast feature is flashing.

In a further embodiment of any of the above, the cast structure includes an internal passage that extends to the cast exterior surface and is covered by the undesired cast feature.

In a further embodiment of any of the above, the method of finishing a cast structure includes the step of grinding a portion of the undesired cast feature prior to performing the electrochemical machining step.

In a further embodiment of any of the above, the grinding step includes exposing the internal passage.

In a further embodiment of any of the above, the cast structure includes a core that provides the internal passage. The method includes the step of dissolving the core from the internal passage prior to performing the electrochemical machining step.

In a further embodiment of any of the above, the grinding step includes producing a ridge adjacent to the internal passage. The electrochemical machining step includes removing the ridge.

In a further embodiment of any of the above, the providing step includes a mold manufacturing step that includes producing a meltable mold to provide a mold of the cast structure.

In a further embodiment of any of the above, the mold manufacturing step includes surrounding a core with wax to produce the meltable mold.

In a further embodiment of any of the above, the mold manufacturing step includes coating the meltable mold in a ceramic slurry.

In a further embodiment of any of the above, the core is a refractory metal.

In a further embodiment of any of the above, the core is ceramic.

In a further embodiment of any of the above, the cast structure is a nickel alloy.

In a further embodiment of any of the above, the electrochemical machining step includes fixturing the cast component relative to a tool, and moving the tool relative to the cast exterior surface.

In a further embodiment of any of the above, the electrochemical machining step includes covering the undesired cast feature with an electrolyte and applying a voltage across the cast structure and the tool.

In a further embodiment of any of the above, the tool is a cathode and the cast structure is anode. The tool removes the undesired cast feature.

In a further embodiment of any of the above, the cast structure is one of a vane, a blade, a blade outer air seal, a combustor liner, an exhaust liner or an augmenter liner.

In a further embodiment of any of the above, the cast structure includes an airfoil.

In a further embodiment of any of the above, the undesired cast feature is at least one of flashing, a gate, a ridge, or an internal passage covering.

### BRIEF DESCRIPTION OF THE DRAWINGS

The disclosure can be further understood by reference to the following detailed description when considered in connection with the accompanying drawings wherein:

FIG. 1 is a schematic view of a gas turbine engine incorporating the disclosed cast structure.

FIG. 2 is a flow chart depicting an example method of finishing a cast structure.

FIG. 3 is a schematic view of an electrochemical machining operation.

FIG. 4A is a cross-sectional view of a cast airfoil.

FIG. 4B is an enlarged view of a portion of the cast airfoil as shown in FIG. 4A.

FIG. 4C is an enlarged view depicting a portion of an undesired cast feature removed.

FIG. 5 schematically depicts flashing.

FIG. 6 schematically depicts a gate.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

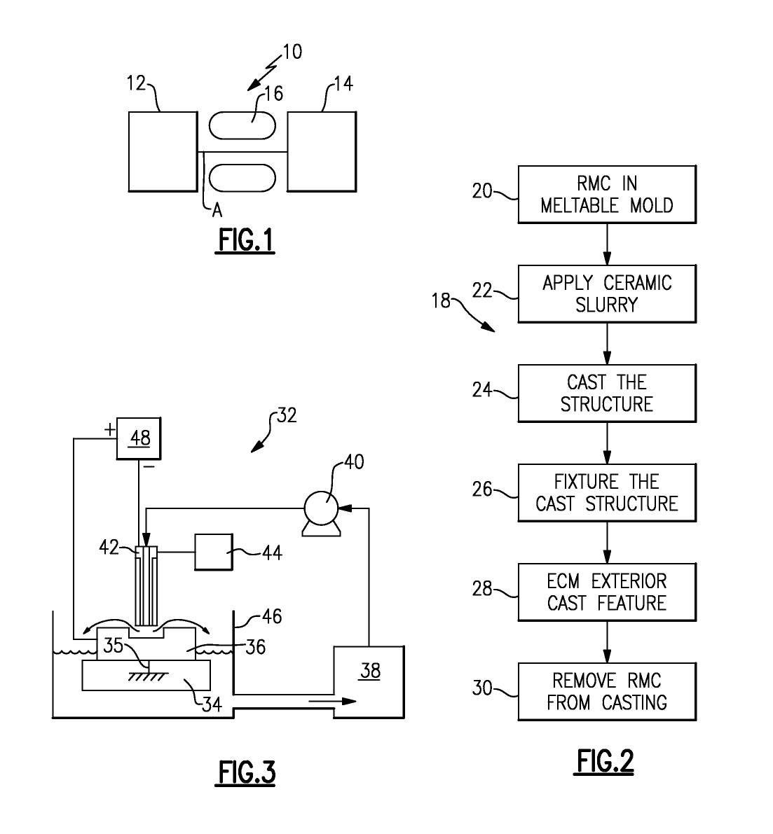

FIG. 1 schematically illustrates a gas turbine engine 10 that includes a compressor section 12, a combustion section 16 and a turbine section 14, which are disposed about a central axis A. As known in the art, air compressed in the compressor section 12 is mixed with fuel that is burned in combustion section 16 and expanded in the turbine section 14. The turbine section 14, in response to expansion of the burned fuel, rotate and drive the compressor section 12.

It should be understood that FIG. 1 is for illustrative purposes only and is in no way intended as a limitation on this disclosure or its application. The engine 10 may be a commercial, a military or an industrial gas turbine engine.

FIG. 2 illustrates a flow chart of an example method 18 of finishing a cast structure. The cast structure may be a gas turbine engine component, such as a vane, a blade, a blade outer air seal, a combustor liner, an exhaust liner, or an augmenter liner, for example.

The method 18 includes providing a meltable mold, as indicated at block 20. The meltable mold corresponds to the shape of a cast structure. The meltable mold may include one or more cores such as refractory metal cores (RMC), which are used to provide intricate internal cooling passages and/or external geometry.

In one typical investment casting process, a coating may be applied to the exterior surface of one or more cores, which enables the core to be more easily removed subsequently. The core is arranged in a multi-piece mold and held in a desired orientation by features on the mold. The core is enveloped in wax to provide a wax airfoil and core assembly with the exterior airfoil portion proud of the wax airfoil, for example.

In another example process, the meltable mold may be formed using an additive manufacturing process, which produces the shape of the component to be cast from a material, such as plastic.

Typically, the meltable mold is coated in a ceramic slurry, as indicated at block 22, to provide a shape of the component to be cast. The meltable mold is then melted, and the component is cast, as indicated at 24. The ceramic airfoil mold is filled with a nickel alloy, for example, to provide the cast structure. The core or cores are eventually removed from the cast component to provide cooling passages, as indicated at block 30. Steps 22, 24 and 30 are performed optionally, and may be performed partially or differently than disclosed.

A typical casting process, whether by investment casting or otherwise, inevitably produces undesired cast features that must be removed from the cast exterior surface. Although electrochemical machining, as subsequently disclosed, is used to replace the costly and often imprecise hand grinding process typically incorporated, a rough grinding or other operation may be used to knock down some of the larger undesired cast features. Additionally, the grinding may be used to expose RMC cores, which then can be dissolved from the cast structure prior to machining.

Once the cast structure has been prepared, as desired, the cast structure is fixtured, as indicated at block 26. The exterior cast surface of the cast structure is electrochemically machined to remove any undesired cast features, as indicated at block 28. If desired, larger portions or the entire cast exterior surface may be electrochemically machined to a finished contour. In this manner, the casting process may be thought of as providing a near-net shape of the final component shape with the electrochemical machining process providing the final contour.

An example electrochemical machining operation 32 is schematically shown in FIG. 3. The cast structure 36 is secured to a fixture 34 by a locating feature 35. In the example of a blade or vane, the locating feature 35 may be provided by a root or platform.

An electrolyte source 38 provides an electrolyte that is transferred to an electrode 42 by a pump 40 and contained within a container 46. An actuating system 44 moves the electrode 42 relative to the cast structure 36 to move the electrode 42 along the cast exterior surface. An automated actuating system 44 may be used to provide the finished contour of the cast structure. A voltage source 48 applies a voltage to the electrode 42 in the cast structure 36. In one example, the electrode acts as a cathode, and the cast structure acts as an anode.

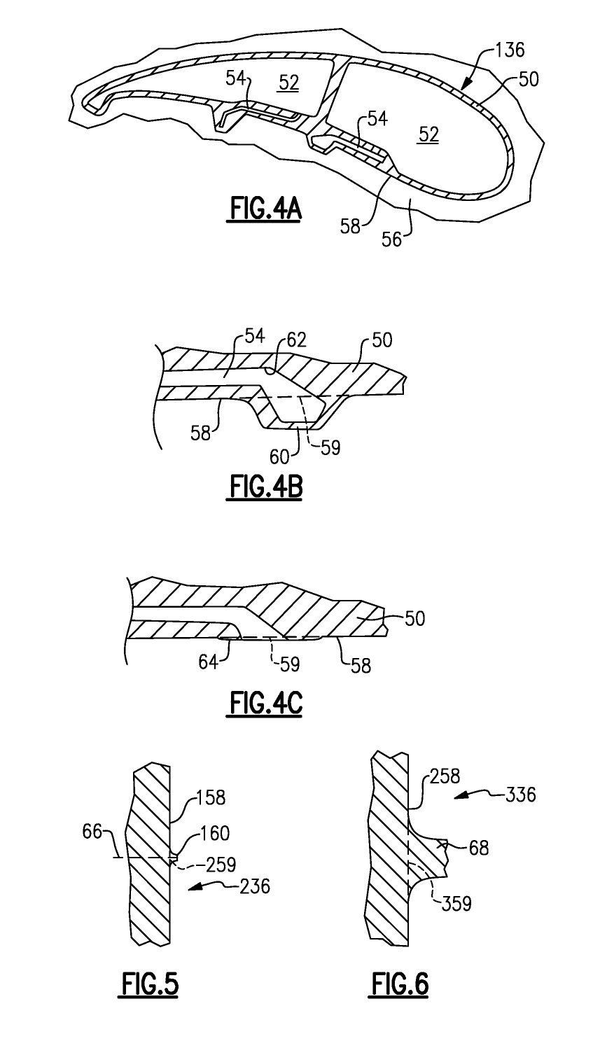

In the example shown in FIG. 4A, the cast structure 136 is an airfoil 50. In one example, the airfoil 50 is formed by multiple cores 52, 54 and a ceramic mold 56, which may be formed by ceramic slurry during the mold manufacturing process. In one example, the core 54 is provided by a refractory metal material to provide intricate internal passages that provide cooling passages in the finished airfoil. During the casting process, an undesired cast feature 60 is produced in the exterior cast surface 58. In the example shown in FIG. 4B, one of the undesired cast features 60 covers the core 52. This undesired cast feature 60 is electrochemically machined to expose core features and/or provide a finished contour 59. As shown in FIG. 4C, the cast feature 60 may be rough ground, which provides a ridge 64 that is electrochemically removed to provide the finished contour 59.

Other undesired cast features may result from the casting process. As shown in FIG. 5, the cast structure 236 includes flashing 160, which may occur at a parting line 66 of the exterior cast surface 158. The flashing 160 is electrochemically removed to provide the finished contour 259. Similarly, gates 68 extend from the exterior cast surface 258 of the cast structure 336 where molten material is poured into the mold. The gate 68 is electrochemically machined to provide the finished contour 359.

Hand finishing of the exterior airfoil surface in the area of the film cooling holes and other areas is no longer required when using the disclosed electrochemical machining process.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of finishing a cast structure, comprising:
providing a cast exterior surface with an undesired cast feature; and
electrochemically machining the undesired cast feature to provide a finished contour.

2. The method according to claim 1, wherein the undesired cast feature is a gate.

3. The method according to claim 1, wherein the undesired cast feature is flashing.

4. The method according to claim 1, wherein the cast structure includes an internal passage that extends to the cast exterior surface and is covered by the undesired cast feature.

5. The method according to claim 2, comprising the step of grinding a portion of the undesired cast feature prior to performing the electrochemical machining step.

6. The method according to claim 5, wherein the grinding step includes exposing the internal passage.

7. The method according to claim 6, wherein the cast structure includes a core providing the internal passage, and comprising the step of dissolving the core from the internal passage prior to performing the electrochemical machining step.

8. The method according to claim 6, wherein grinding step includes producing a ridge adjacent to the internal passage, and the electrochemical machining step includes removing the ridge.

9. The method according to claim 1, wherein the providing step includes a mold manufacturing step that includes producing a meltable mold to provide a mold of the cast structure.

10. The method according to claim 9, wherein the mold manufacturing step includes surrounding a core with wax to produce the meltable mold.

11. The method according to claim 9, wherein the mold manufacturing step includes coating the meltable mold in a ceramic slurry.

12. The method according to claim 9, wherein the core is a refractory metal.

13. The method according to claim 9, wherein the core is ceramic.

14. The method according to claim 1, wherein the cast structure is a nickel alloy.

15. The method according to claim 1, wherein the electrochemical machining step includes fixturing the cast component relative to a tool, and moving the tool relative to the cast exterior surface.

16. The method according to claim 15, wherein the electrochemical machining step includes covering the undesired cast feature with an electrolyte, and applying a voltage across the cast structure and the tool.

17. The method according to claim 16, wherein the tool is a cathode and the cast structure is anode, the tool removing the undesired cast feature.

18. The method according to claim 1, wherein the cast structure is one of a vane, a blade, a blade outer air seal, a combustor liner, an exhaust liner or an augmenter liner.

19. The method according to claim 18, wherein the cast structure includes an airfoil.

20. The method according to claim 19, wherein the undesired cast feature is at least one of flashing, a gate, a ridge, or an internal passage covering.
